(19) United States
(12) Patent Application Publication
(10) Pub. No.: US 2020/0274171 A1
(43) Pub. Date: Aug. 27, 2020

(54) METHOD FOR PRODUCING SUPPORTED PLATINUM PARTICLES

(71) Applicant: Heraeus Amloy Technologies GmbH, Hanau (DE)

(72) Inventors: Markus Nesselberger, Frankfurt (DE); Frederic Hasche, Berlin (DE); Rianne Schöffler, Wernau (DE); Florian Eweiner, Hanau (DE); Mark Neuschütz, Muhltal (DE)

(21) Appl. No.: 16/757,690

(22) PCT Filed: Oct. 19, 2018
(86) PCT No.: PCT/EP2018/078752

§ 371 Date: Apr. 20, 2020

(30) Foreign Application Priority Data
Oct. 23, 2017 (EP) 17197763.0

(51) Int. Cl. H01M 4/92; C25B 11/04

(52) U.S. Cl. CPC H01M 4/926; C25B 11/0473

(57) ABSTRACT

The present invention relates to a method for the production of a catalyst composition, wherein a support material in the form of carbon particles is impregnated with a platinum compound in an aqueous medium, and the impregnated support material is contected with a reducing agent in the aqueous medium while stirring at a pH in the range of 3.5-6.0 and a Reynolds number of the stirrer of at least 50,000.

The present invention relates to the production of supported platinum particles and to the use thereof as catalyst in fuel or electrolysis cells.

It is known that platinum particles, which are applied to a support material such as, e.g., carbon, are used as catalysts for fuel cells (for example proton exchange membrane (PEM) fuel cells) or electrolysis cells (for example for the water electrolysis). As components, these supported catalyst compositions include the catalytically active material (platinum particles) and the support material (e.g. carbon particles), which is usually also present in the form of particles. The reactions, which are catalyzed by means of this catalyst system, are surface reactions. The available platinum surface is thus of vital importance and should be as large as possible (maximization of the accessible platinum surface). This implies making the platinum particles as small as possible, in order to attain the largest possible ratio of surface to volume. However, a decreasing particle size of these platinum particles leads to a lower stability in the used electrochemical environment. It is thus necessary on the one hand to design the platinum particles as large as necessary in order to attain a sufficient stability, but to keep them as small as possible, in order to attain a sufficiently high compound activity (i.e. a current, which is standardized to the platinum compound, at a given voltage).

To maximize the electrochemically active platinum surface (sum of the surface of all platinum particles, which is electrochemically accessible), it is required to distribute the platinum particles as homogenously as possible and with a high degree of dispersion on the support. The synthesis conditions should furthermore be selected in such a way that the platinum particles form predominantly on the support, while the formation of unsupported platinum particle agglomerates is avoided, if possible.

J. C. Meier et al., Beilstein J. Nanotechnol., 2014, 5, S. 44-67, describe catalyst compositions for fuel cells, which include carbon as support material and platinum particles. The properties of the carbon-supported platinum particles are summarized in Table 1. The particle sizes of the platinum particles were determined by means of TEM images. Due to the fact that only a very limited number of platinum particles is considered with this method and due to the fact that platinum particles, which are present, for example, in the pores of the support material, are not captured reliably, TEM does not allow for a reliable determination of the particle size distribution of the platinum particles. According to Table 1 of the publication, compound activities of between 0.32 A/mg Pt and 0.35 A/mg Pt were determined in the case of an average size of the platinum particles of 3-4 nm in HClO₄, which was determined via TEM.

In response to a further reduction of the average particle size of the platinum particles to 1-2 nm, compound activities of more than 0.40 A/mg Pt could be attained. Due to the very small particle size, however, the stability of the platinum particles decreases significantly.

A number of methods are known for the production of carbon-supported platinum particles, see, e.g., the overview article by K. B. Kokoh et al., Catalysts, 2015, 5, pages 310-348. The formation of platinum particles on a carbon support can take place, for example, via the microemulsion method, the polyol method or a method, in the case of which the support is initially impregnated with a platinum compound and this platinum compound is subsequently reduced to metallic platinum.

Surfactants, which can be adsorbed on the surface of the forming platinum particles and which have to be removed prior to the use of the supported platinum particles as catalyst, are typically used in the case of the microemulsion method.

In the case of the polyol method, the polyvalent alcohol (e.g. ethylene glycol) acts as solvent and as reducing agent. Compounds, which interact with the surface of the forming platinum particles and which thus stabilize the particles, are created in response to the oxidation of the polyol. These adsorbed compounds have to be removed by means of a suitable treatment (e.g. thermal treatment or washing with an acid) prior to the use of the supported platinum particles as catalyst.

As already mentioned above, it is also known to first impregnate a carbon-based support material, which is dispersed in an aqueous medium, with a platinum compound acting as precursor (impregnating step), and to subsequently reduce the platinum compound, which is present on the support material, to metallic platinum (reduction step).

For the reduction step, the support material, which has been impregnated with the platinum compound, can be removed from the aqueous medium and can be dried, in order to subsequently be treated with a reducing gas, such as hydrogen, at a higher temperature. This, however, can lead to an agglomeration of adjacent platinum particles and thus to an unwanted increase of the particle size, which is also difficult to control.

In the alternative, the reduction of the platinum compound, which is present on the support material, can already be performed in the aqueous medium. For example NabH₄, formic acid, hydrogen (H₂), sodium thiosulphate, formaldehyde or hydrazine can be used as reducing agent.

US 2006/0099483 A1 describes a method for producing a support material, to which catalyst particles can be applied. For example an inorganic oxide, such as SiO₂, is mixed with a carbon-based material (e.g. carbon black or activated carbon) and is subjected to a heat treatment in this method. Metallic particles can be applied to the support material obtained thereby via an impregnating process with subsequent reduction. The inorganic oxide of the support material can be partially removed again via a treatment with an acid or base.

One object of the present invention is the production of supported platinum particles (i.e. present on the support material) via a method, which can be performed easily and efficiently and which distributes the particles as homogenously as possible and with a high degree of dispersion on the support, while the formation of unsupported, agglomerated platinum particles is avoided, if possible. A further object of the present invention is the provision of a catalyst composition on the basis of supported platinum particles, which has good catalytic properties, in particular a high compound activity.

The invention is solved by means of a method for the production of a catalyst composition, wherein
(i) a support material in the form of carbon particles is impregnated with a platinum compound in an aqueous medium,
(ii) the impregnated support material is brought into contact with a reducing agent in the aqueous medium while stirring at a pH in the range of 3.5-6.0 and a Reynolds number of the stirrer of at least 50,000.

It has been recognized as part of the present invention that a high degree of dispersion of metallic platinum particles on the support material with a simultaneously very low percentage of unsupported platinum particles can be realized, when both of the above-mentioned conditions, thus a pH in the range of 3.5-6.0 and furthermore a sufficiently high Reynolds number of the stirrer of at least 50,000 (i.e. a sufficiently turbulent mixing of the aqueous medium) are maintained for the reduction step (ii). If one of these process parameters is not maintained, this can lead to an uneven distribution of the metallic platinum particles on the support material and/or to the formation of unsupported platinum particle agglomerates, as will be shown by the examples below.

As is known to the person of skill in the art, the Reynolds number represents a measure in the field of stirring technology (also known in this context as Reynolds number of the stirrer), for how intensively a liquid medium is stirred. For values of the Reynolds number of the stirrer of more than 10,000, a liquid medium is considered as having been mixed turbulently.

As part of the present invention, however, this lower limit for a turbulent mixing has to be significantly exceeded. In combination with the pH range according to the invention, this leads to a very high degree of dispersion of the supported particles, while the formation of unsupported platinum particles is suppressed very effectively.

Suitable support materials in the form of carbon particles, which can act as support for platinum particles, are generally known to the person of skill in the art.

Carbon black, e.g. acetylene black, channel black, furnace black, lamp black or thermal black, activated carbon, pyrolytic carbon, graphite, a carbide-derived carbon, carbon nanotubes, graphene, mesoporous carbons, nitrogen- or boron-doped carbons or a mixture of at least two of these carbon materials can be named in an exemplary manner.

The carbon-based support material preferably has a high BET surface, in order to support the formation of finely dispersed platinum particles in this way. The support material has, for example, a BET surface of at least 10 m²/g, more preferably at least 50 m²/g or at least 150 m²/g, e.g. 10-2000 m²/g or 50-1500 m²/g or 150-1300 m²/g.

The carbon-based support material can optionally be porous. The support material has, for example, a pore volume of at least 0.1 ml/g, more preferably at least 0.2 ml/g or at least 0.3 ml/g, e.g. 0.1-4.0 ml/g or 0.2-3.5 ml/g or 0.3-3.0 ml/g.

These support materials are commercially available or can be produced via methods, which are known to the person of skill in the art.

Platinum compounds, which can be used for the impregnation of a support material and for a subsequent reduction to metallic platinum, are known to the person of skill in the art.

The platinum compound is, for example, a Pt(II) or a platinum (IV) compound, e.g. a Pt(II) or Pt(IV) salt or a Pt(II) or Pt(IV) complex compound or a Pt organometallic compound. Hexachloroplatinic acid or a salt of this acid, a platinum nitrate, a platinum halide, platinum acetylacetonate or platinum oxalate or a mixture of at least two of these compounds can be named as exemplary platinum compounds.

Provided that the metallic platinum particles, which are to be generated by means of the method according to the invention, are to still contain an alloying element, one or a plurality of metal compounds can also be added to the aqueous medium in addition to the platinum compound. In this case, the carbon particles, which act as support material, are not only impregnated with the platinum compound, but also with the additional metal compound. This further metal compound can be, for example, a compound of one of the following metals: Ru, Pd, Ir, Cr, Co, Ni, Cu, Fe, Mn, W, V. This further compound can be, for example, a salt, a complex or an organometallic compound.

The aqueous medium preferably has a water content of more than 50% by volume, more preferably more than 70% by volume.

For the impregnating step, the carbon-based support material and the platinum compound, which is to be deposited on the support material, can be introduced simultaneously as well as one after the other into the aqueous medium. First of all, the support material is dispersed for example in the aqueous medium and the platinum compound is subsequently metered in (e.g. in the form of an aqueous solution).

Suitable conditions for the impregnating of the carbon-based support material with the platinum compound are known to the person of skill in the art. The aqueous medium is preferably stirred during the impregnating step. The stirring power can thereby be varied over a broad range. For example, the impregnating step can also be performed at a Reynolds number of the stirrer of at least 50,000 or at least 75,000 or even at least 90,000 (e.g. 50,000-200,000 or 75,000-180,000 90,000-150,000). In the alternative, it is also possible to perform the impregnating step at a Reynolds number of the stirrer of less than 50,000.

The pH of the aqueous medium during the impregnating step can be varied over a broad range. During the impregnating step, the aqueous medium has a pH of, for example, maximally 6.0.

During the impregnating step, the temperature of the aqueous medium is, for example, 20° C.-95° C., preferably 40° C. to 90° C. or 60° C. to 80° C. The density and dynamic viscosity of water at this temperature T are used for the determination of the Reynolds number of the stirrer during step (i).

The mass ratio of the platinum, which is present in the platinum compound, to the support material is, for example, 1/10-8/10, more preferably 2/10-7/10.

In the aqueous medium, the support material is present in a quantity of, for example, between 0.05% by weight and 2.5% by weight, more preferably between 0.1 and 2.0% by weight.

The duration of the impregnating step is selected in such a way that a sufficient quantity of the platinum compound can deposit on the carbon particles, which act as support material. The person of skill in the art can determine a suitable time period on the basis of routine tests.

During the impregnating step, the platinum compound is adsorbed on the support material, i.e. on the surface of the carbon particles. In the case of porous carbon particles, this can also be an inner surface, i.e. a surface located inside the pores. An impregnated support material is obtained as result of step (i).

As already mentioned above, the impregnated support material is brought into contact with a reducing agent in the aqueous medium by stirring at a pH in the range of 3.5-6.0 and a Reynolds number of a stirrer of at least 50,000 in the reduction step (ii).

By bringing into contact with the reducing agent, metallic platinum particles form on the support material (i.e. on the surface of the carbon particles). The catalyst composition produced by means of the method according to the invention contains the metallic platinum particles, for example, in a quantity of 5-60% by weight, more preferably 15-50% by weight or 25-50% by weight.

In the field of stirring technology, the Reynolds number of the stirrer represents a measure for how intensively a liquid medium is stirred. For values of the Reynolds number of the stirrer of more than 10,000, a liquid medium is considered as having been turbulently mixed. The determination of the Reynolds number of the stirrer at a temperature T_{R} takes place in the known way on the basis of the following formula:

R=(ρ*N*D²)/η
where
R is the Reynolds number of the stirrer,
ρ is the density of water in kg/m³ at the temperature T_{R},
N is the speed of the stirrer in revolutions per second,
D is the maximum diameter of the stirrer,
η is the dynamic viscosity of water in kg/(m*s²) at the temperature T_{R}.

The density and dynamic viscosity of water as a function of the temperature are generally known. The maximum diameter D of the stirrer is determined perpendicular to the stirring axis.

Conventional stirrers can be used for the stirring of the aqueous medium during the reduction step (ii). By adjusting a sufficiently high stirring speed it is ensured that the reduction takes place at a Reynolds number of the stirrer of at least 50,000. For example anchor stirrers, screw stirrers, disk stirrers, impeller stirrers, propeller stirrers or inclined-blade stirrers can be named as suitable stirrers.

Step (ii) can be performed in common reactors, which are known to the person of skill in the art.

In step (ii), the ratio of the maximum stirrer diameter D to the maximum inner diameter r_{eactor} of the reactor, which is used in step (ii), is at least 0.4, more preferably at least 0.5 or at least 0.6. In a preferred embodiment, the following applies:

0.3≤D/r_{eactor}<1.0;

more preferably:

0.4≤D/r_{eactor}≤0.98

or

0.5≤D/r_{eactor}≤0.90.

The person of skill in the art can determine a suitable fill level for the aqueous medium, with which the reactor is filled in step (ii), based on his expert knowledge. For example, the fill level H and the maximum inner diameter r_{eactor} of the reactor meets the following condition:

0.5≤H/r_{eactor}<2.0.

For performing steps (i) and (ii), the same reactor and the same stirrer are preferably used.

Formic acid, a metal boron hydride (e.g. an alkaline metal boron hydride, such as NaBH₄ and LiBH₄), an alkaline metal hydride (e.g. sodium hydride), hydrogen (H₂), a metal thiosulfate (e.g. an alkaline metal thiosulfate, such as NaS₂O₃), an aldehyde (e.g. formaldehyde), an alcohol, (e.g. a monohydroxy alcohol, such as isopropanol), hydrazine, hydrazine hydrate, hydrazine hydrochloride or ascorbic acid or a mixture of at least two of these reducing agents can be used, for example, as reducing agent.

The person of skill in the art can determine a suitable temperature T_{R} for the reduction step (i.e. a suitable temperature of the aqueous medium during the reduction step (ii)) as a function of the used reducing agent on the basis of his expert knowledge. The temperature T_{R} of the aqueous medium in step (ii) lies, for example, in the range of between 20° C. and 95° C., more preferably between 30° C. and 90° C. or between 50° C. and 80° C. The density and dynamic viscosity of water at this temperature T_{R} are used for the determination of the Reynolds number of the stirrer.

The Reynolds number of the stirrer in step (ii) is preferably at least 75,000, more preferably at least 90,000. In a preferred embodiment, the Reynolds number of the stirrer is 50,000-200,000, more preferably 75,000-180,000, even more preferably 90,000-150,000.

The pH of the aqueous medium in step (ii) preferably lies in the range of 4.5-5.6, more preferably 4.9-5.3.

With the reduction, the platinum compound, which is present on the carbon particles, which act as support material, is reduced to metallic platinum, and metallic nanoparticles form on the support material (i.e. on the carbon particles). Provided that the support material has been impregnated with further metallic compounds, a platinum alloy can be obtained by means of the reduction, for example a platinum alloy, which contains one or a plurality of the following metals: Ru, Pd, Ir, Cr, Co, Ni, Cu, Fe, Mn, W, V.

After the reduction of the platinum compound to metallic platinum particles has taken place (which can be elementary platinum or a platinum alloy), the catalyst composition can be isolated from the aqueous medium and can be subjected to a drying via common methods.

A catalyst composition, which has very good catalytic properties, in particular a very high compound activity, can be obtained via the above-described method.

The present invention thus furthermore relates to a catalyst composition comprising
a support material in the form of carbon particles,
metallic platinum particles, which are present on the support material, and a volume weighted particle size distribution, determined via small-angle x-ray scattering, with a d₁₀ value of ≥2.0 nm and d₉₀ value of ≤7.0 nm.

In a preferred embodiment, the volume weighted particle size distribution of the platinum particles has a median value d₅₀, which lies in the range of 3.0-5.0 nm, more preferably 3.5-4.5 nm.

Preferably, d₁₀≥2.0 nm and d₉₀≤6.5 nm, more preferably d₁₀≥2.3 nm and d₉₀≤6.0 nm.

Preferably, the d₁₀, d₉₀ and d₅₀ values of the particle size distribution of the platinum particles satisfy the following condition:

(d₉₀−d₁₀)/d₅₀≤1.0

Even more preferably, the following conditions apply:

0.5≤(d₉₀−d₁₀)/d₅₀≤1.2

or

0.6≤(d₉₀−d₁₀)/d₅₀≤0.9

The catalyst composition contains the metallic platinum particles, for example in a quantity of 5-60% by weight, more preferably 15-50% by weight or 25-50% by weight.

Preferably, the platinum particles do not contain a further metallic element, apart from unavoidable impurities (i.e. the platinum is present in elementary form). In the alternative, it is also possible that the platinum is present in the form of a platinum alloy. The platinum alloy can contain, for example, one or a plurality of the following metals: Ru, Pd, Ir, Cr, Co, Ni, Cu, Fe, Mn, W, V.

With regard to the preferred properties of the carbon-based support material, reference can be made to the above statements.

Carbon black, e.g. acetylene black, channel black, furnace black, lamp black or thermal black, activated carbon, pyrolytic carbon, graphite, a carbide-derived carbon, carbon nanotubes, graphene, mesoporous carbons, nitrogen- or boron-doped carbons or a mixture of at least two of these carbon materials can be named in an exemplary manner.

The support material preferably has a BET surface of at least 10 m²/g, more preferably at least 50 m²/g or at least 150 m²/g auf, e.g. 10-2000 m²/g or 50-1500 m²/g or 150-1300 m²/g. The support material can optionally be porous. The support material has, for example, a pore volume of at least 0.1 ml/g, more preferably at least 0.2 ml/g or at least 0.3 ml/g, e.g. 0.1-4.0 ml/g or 0.2-3.5 ml/g or 0.3-3.0 ml/g.

The catalyst composition preferably consists of at least 90% by weight, more preferably of at least 95% by weight or even at least 98% by weight of the carbon-based support material and the platinum particles.

The surface of the platinum particles is preferably free from surface-active substances.

In a preferred embodiment, the catalyst composition can be obtained via the above-described method according to the invention.

The present invention furthermore relates to an electrochemical cell, in particular a fuel or electrolysis cell, containing the above-described catalyst composition.

The fuel call can be, for example, a proton exchange membrane(PEM) fuel cell, e.g. a hydrogen or a methanol-PEM fuel cell. The electrolysis cell is preferably an electrolysis cell for the water electrolysis, in particular a PEM water electrolysis cell.

The present invention furthermore relates to the use of the above-described composition as catalyst for an electrochemical reaction.

This electrochemical reaction is, for example, the electrochemical reduction of oxygen (“oxygen reduction reaction”, ORR), the electrochemical oxidation of hydrogen (“hydrogen oxidation reaction”, HOR), the electrochemical formation of oxygen from water (“oxygen evolution reaction”, OER) or the electrochemical formation of hydrogen from water (“hydrogen evolution reaction”, HER).

The measuring methods used in the present invention are specified below.

### Reynolds Number:

The determination of the Reynolds number of the stirrer at a temperature T_{R} takes place on the basis of the following formula:

R=(ρ*N*D²)/η
where
R is the Reynolds number of the stirrer,
ρ is the density of water in kg/m³ at the temperature T_{R},
N is the speed of the stirrer in revolutions per second,
D is the maximum diameter of the stirrer,
η is the dynamic viscosity of water in kg/(m*s²) at the temperature T_{R}.

The density and dynamic viscosity of water as a function of the temperature are generally known. The maximum diameter D of the stirrer is determined perpendicular to the stirring axis.

### Determination of the pH:

The determination of the pH took place by means of a Mettler Toledo SevenCompact, equipped with an InLab Reach Pro-425 electrode. Electrode type: pH combination electrode; diaphragm type: ceramic; reference electrolyte: 3 mol/l KCl; shaft material: glass; reference electrode: Ag/AgCl.

The electrode is calibrated prior to the measurement.

Particle size distribution, d₁₀, d₅₀ and d₉₀ values:

The particle size distribution was determined via small-angle x-ray scattering.

The “Bragg-Brentano” device X'Pert Pro is operated in transmission geometry and the primary beam is provided with a mirror, in order to create a collimated beam. Catalyst material (10-20 mg) is applied between two mylar foils in a transmission sample holder. A sample holder with the corresponding support material is required for the determination of the substrate. The radiation source was a Cu x-ray tube with the standard excitation of 40 kV & 40 mA and with the wavelength of 0.1542 nm.

The obtained scattering curves after the substrate removal were evaluated by means of PANalytical EasySAXSSoftware (Ver. 2.0). The particle size distribution curves were calculated by means of the algorithms, which are implemented in this software.

The principle is that the scattering curve I(q) resulting from the measurement is associated with the particle size distribution D_{V}(R) via the following integral:

I(q)=∫_{R=0}^{R=R}^{ₘₐₓ}D_{V}(R)·R₃·I₀(q,R)dR

The used symbols are defined as follows:
q: scattering vector
D_{V}(R): volume weighted particle size distribution
R: particle radius

Due to the fact that the indirect Fourier transformation of the above equation is highly sensitive to the noise in measurement data, the D_{V}(R) determined is carried out on the basis of an iterative process. The distribution curve D_{V}(R) resulting from this determination represents the volume weighted particle size distribution (distribution according to particle volume); this is associated as follows with the number weighted particle size distribution D_{N}(R):

$${D}_{V} ( R ) \text{∼} \frac{4 n}{3} {R}^{3} \cdot {D}_{{ }_{N}} ( R )$$

For the determination of the particle size distribution with the D_{V}(R) function, it is assumed that an ensemble of homogenous, non-interacting, spherical particles is present. The algorithm uses an indirect Fourier transformation, which is described in the following reference: D. I. Svergun et al., Acta Cryst., A44, 1988, pages. 244-250.

An assumption about the shape of the distribution curve is not made thereby. A particle volume weighted size distribution is obtained.

The d₁₀, d₅₀ and d₉₀ values can be determined on the basis of the particle size distribution of the platinum particles. The dₓ value specifies the volume weighted portion x (in %) of the particles lies below this particle size.

### Measurement Setup for Electrochemical Measurements:

The measurements of the electrochemical parameters, such as compound activity and electrochemically active surface, were performed by means of rotating disk electrode (RDE).

All measurements were performed in a measuring cell comprising three Teflon containers in 0.1 M HClO₄ electrolytic solution at room temperature, using a Hg/Hg₂SO₄ reference electrode (Schott Instruments GmbH), a platinum gauze as counter electrode and a potentiostat.

20 μl of an aqueous catalyst dispersion were applied on a sample body, which had previously been polished to mirror finish, with glassy carbon substrate (diameter: 5 mm; 0.196 cm² Pine Research Instrumentation AFE5T050GC) and were dried in a closed manner in air atmosphere. The sample produced in this way had a precious metal charge of 14 μg_{Pt}cm⁻² and was fastened to a rotating electrode (Pine Research Instrumentation AFMSRCE). All measurements, determination of the electrochemically active surface, as well as the determination of the compound activity, have been performed by means of compensated electrolyte resistance. For this purpose, the average value of the Ohmic percentage of the electrolyte resistance was determined prior to the measurement at 4 kHz, 5 kHz, 6 kHz, and was compensated to a residual resistance of 2 Ohm by means of the “iR compensation” function of the potentiostat

### Determination of the Electrochemical Surface (EASA):

The electrochemically active surface was determined from the measured charge of the hydrogen underpotential deposition. The polarization curves in argon-saturated electrolyte with a potential feed rate of 50 mVs⁻¹ served this purpose. The charge follows after deducting the electrochemical double layer capacity from the integration of the current over time. 200 μCcm⁻² is assumed as the conversion factor for determining the platinum surface.

### Determination of the Compound Activity:

The compound activity was determined from the anionic polarization curve in oxygen-saturated electrolyte with a potential feed speed of 50 mVs⁻¹ and a rotation rate of 1600 min⁻¹ of the disk electrode after deduction of the polarization curve in argon.

### Bet Surface:

The BET surface is determined by means of nitrogen sorption at 77 K by using the BET method.

### Pore Volume:

The pore volume is determined by means of nitrogen sorption at 77 K and a relative pressure of P/P₀=0.99.

The present invention will be described in more detail on the basis of the following examples.

### EXAMPLES

### Example 1

### Impregnating Step (i):

6 g of carbon black, commercially available as Vulcan® XC72-R with a BET surface of approximately 250 m²/g, were slurried with 100 ml of water, placed into a double-shell reactor, and were filled with water to 2 L. The Reynolds number of the stirrer was set to 100,854, and the suspension was heated to 70° C. After a holding time of 1 hour, 40 g of a nitric H₂PtCl₆ solution (10% by weight of Pt) was metered in, and was subsequently held for 1 hour at constant mixing and temperature.

### Reduction Step (ii):

By adding Na₂CO₃, the pH of the aqueous medium was set to a value of 5.1. The formic acid, which acted as reducing agent, was then added. The Reynolds number of the stirrer was 100,854, and the temperature of the aqueous medium was 70° C. The ratio of the maximum stirrer diameter D to the maximum inner diameter r_{eactor} of the reactor was 0.69. During the reduction, the platinum compound, which was present on the carbon particles, was reduced to metallic platinum. Carbon particles were obtained, on which metallic platinum particles are supported. After 0.5 hours, the catalyst composition was filtered from the aqueous medium and was dried at 110° C. in nitrogen atmosphere. The platinum content of the catalyst composition was 40% by weight.

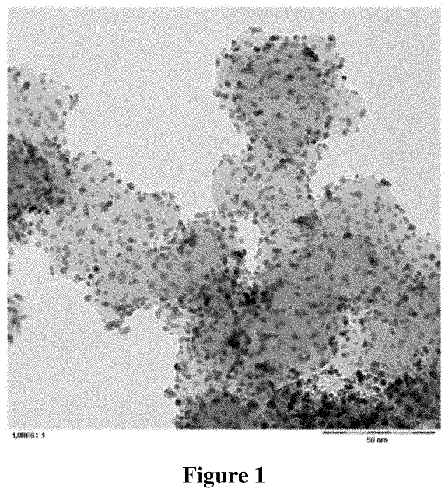

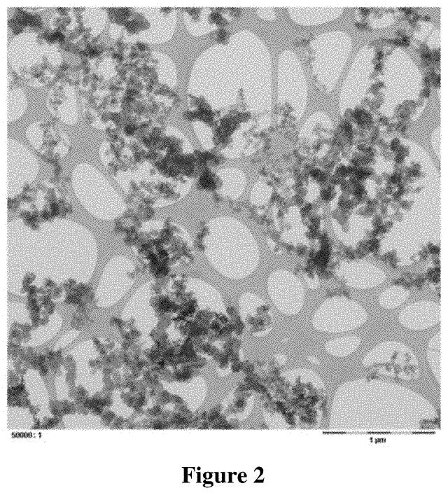

TEM images of the catalyst composition were taken in different magnifications. These TEM images are shown in FIGS. 1 and 2.

It can be seen from FIG. 1, which only shows a few carbon particles in high magnification that the metallic platinum particles are distributed highly homogenously with a high degree of dispersion over the carbon particles, which act as support material.

It can be seen from FIG. 2, which, compared to FIG. 1 shows a significantly larger number of carbon particles that the platinum particles are supported virtually exclusively on the carbon particles. The formation of unsupported and agglomerated platinum particles was thus suppressed virtually completely.

The process conditions of the reduction step and the properties of the supported catalyst composition, which can be seen from the TEM, are summarized in Table 1 below.

The particle size distribution of the platinum particles is determined via small-angle x-ray scattering. The d₁₀, d₅₀ and d₉₀ value were determined on the basis of the particle size distribution. The electrochemically active surface (EASA) and the compound activity were furthermore determined for the catalyst composition of Example 1.

The results are summarized below in Table 2.

### Comparative Example 1

In Comparative Example 1, the catalyst composition was produced under the same process conditions as in Example 1, but with the following deviation: The pH of the aqueous medium was 8.0 during the reduction step (ii). Stirrer and reactor of the Comparative Example 1 corresponded to the stirrer and the reactor of Example 1.

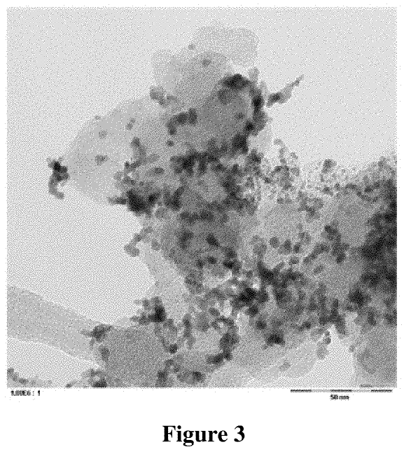

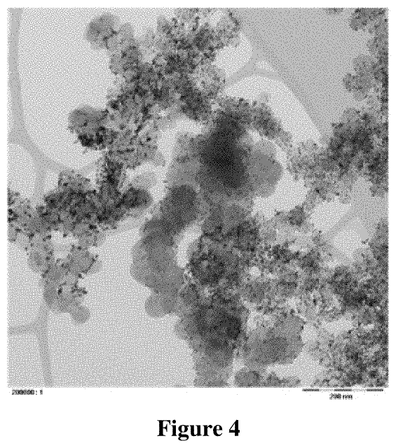

TEM images of the catalyst composition were taken with different magnifications. These TEM images are shown in FIGS. 3 and 4.

It can be seen from FIG. 3, which shows only a few carbon particles in high magnification, that the metallic platinum particles, which are present on the carbon particles, have a significantly inferior degree of dispersion as compared to the sample from Example 1. It can be seen from FIG. 4, which, compared to FIG. 3 shows a significantly larger number of carbon particles, that the majority of the platinum particles is supported on the carbon particles.

The process conditions of the reduction step and the properties of the supported catalyst composition, which can be seen from the TEM images, are summarized in Table 1 below.

The particle size distribution of the platinum particles was determined via small-angle x-ray scattering. The d₁₀, d₅₀ and d₉₀ value were determined on the basis of the particle size distribution. The electrochemically active surface (EASA) and the compound activity were furthermore determined for the catalyst composition of Example 1.

The results are summarized below in Table 2.

### Comparative Example 2

In Comparative Example 2, the catalyst composition was produced under the same process conditions as in Example 1, but with the following deviation: During the reduction step (ii), the Reynolds number of the stirrer was 40,419. The stirrer of Comparative Example 2 corresponded to the stirrer of Example 1, but was operated with a different Reynolds number of the stirrer. The reactor of Comparative Example 2 also corresponded to the reactor used in Example 1.

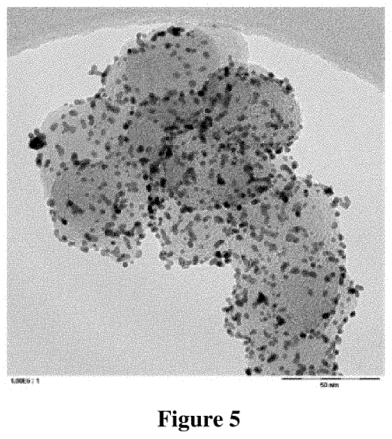

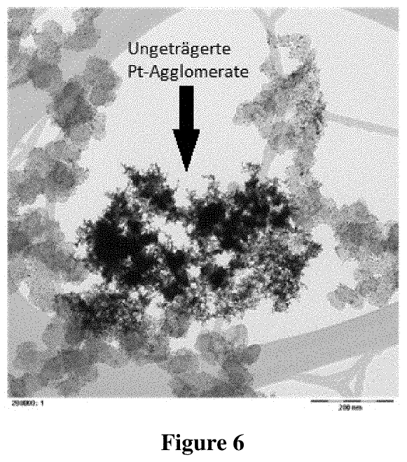

TEM images with different magnifications were taken of the catalyst composition. These TEM images are shown in FIGS. 5 and 6.

It can be seen from FIG. 5, which shows only a few carbon particles in high magnification, that the metallic platinum particles, which are present on the carbon particles, have a high degree of dispersion. It can be seen from FIG. 6, however, that significant quantities of unsupported, agglomerated platinum particles have formed.

The process conditions of the reduction step and the properties of the supported catalyst composition, which can be seen from the TEM images, are summarized below in Table 1.

TABLE 1
Process conditions of the reduction step
and properties of the Pt particles

| | | Comparative | Comparative |
|---|---|---|---|
| | Example 1 | Example 1 | Example 2 |
| pH during the reduction step (ii) | 5.1 | 8.0 | 5.1 |
| Reynolds number of the stirrer | 100,854 | 100,854 | 40,419 |
| during the reduction step (ii) | | | |
| Level of dispersion of the Pt | very good | average | very good |
| particles on the carbon | | | |
| particles (from TEM image) | | | |
| Percentage of unsupported Pt | very low | low | very high |
| particles (from TEM image) | | | |

As shown in Table 1, a high degree of dispersion of the supported platinum particles while virtually completely avoiding unsupported platinum particles are obtained only when the pH as well as the Reynolds number of the stirrer for the reduction step lie within the ranges according to the invention.

When the reduction is performed at a Reynolds number of the stirrer, which is too low, the platinum particles, which are present on the carbon particles show a high degree of dispersion, but a significant percentage of unsupported platinum particles (i.e. not present on the carbon particles) is present, see Comparative Example 2.

When the reduction occurred at a very high Reynolds number (i.e. in accordance with the invention), but the pH was not in accordance with the invention, the percentage of unsupported Pt agglomerates can be kept relatively low, but the platinum particles supported on the carbon particles do not have a high degree of dispersion.

The particle sizes of the platinum particles, the electrochemically active surface, and the compound activity were determined for the samples of Example 1 and of Comparative Example 1 (i.e. the samples, in which the platinum particles are present in a predominantly supported manner). The results are shown in Table 2.

TABLE 2
particle sizes, EASA, and compound activity of the Pt particles

| | | Comparative |
|---|---|---|
| | Example 1 | Example 1 |
| d₁₀ [nm] | 2.6 | 3.0 |
| d₅₀ [nm] | 3.8 | 5.3 |
| d₉₀ [nm] | 5.2 | 19.0 |
| (d₉₀ − d₁₀)/d₅₀ | 0.7 | 3.0 |
| electrochemically active | 65 | 50 |
| surface (EASA) [m²/g] | | |
| compound activity [A/g Pt] | 464 | 374 |

A compound activity of significantly more than 400 A/g Pt was obtained by means of the catalyst composition according to the invention. In spite of this very high compound activity, the composition only has an extremely low percentage of very small Pt particles with a diameter of less than 2 nm (see d₁₀ value in Example 1), which has a positive effect on the stability of the Pt particles under the highly corrosive conditions of a fuel cell or electrolysis cell.

1. A method for the production of a catalyst composition, the method comprising:
(i) impregnating, in an aqueous medium, a support material in the form of carbon particles with a platinum compound to form an impregnated support material,
(ii) contacting the impregnated support material with a reducing agent in the aqueous medium while stirring with a stirrer at a pH in the range of 30.5-6.0, wherein a Reynolds number of the stirrer is at least 50,000.

2. The method of claim 1, wherein the support material is carbon black, activated carbon, pyrolytic carbon, graphite, a carbide-derived carbon, carbon nanotubes, graphene, a mesoporous carbon, a nitrogen and/or boron-doped carbon or a mixture of at least two of these carbon materials, and/or wherein the platinum compound is a platinum (II) or a platinum (IV) compound.

3. The method of claim 1, wherein the impregnating of the support material takes place at a pH of the aqueous medium of ≤6.

4. The method of claim 1, wherein the reducing agent in step (ii) is a formic acid, a metal boron hydride, an alkaline metal hydride, hydrogen, a metal thiosulfate, an aldehyde, hydrazine, hydrazine hydrate, hydrazine hydrochloride or ascorbic acid or a mixture of at least two of these reducing agents.

5. The method of claim 1, wherein the Reynolds number of the stirrer in step (ii) lies in the range of 75,000-180,000, and/or the pH of the aqueous medium in step (ii) lies in the range of 4.5-5.6.

6. The method of claim 1, wherein the aqueous medium in step (ii) has a temperature T_{R} in the range of between 20° C. and 95° C.

7. A catalyst composition comprising:
a support material in the form of carbon particles,
metallic platinum particles, which are present on the support material, and a volume weighted particle size distribution, determined via small-angle x-ray scattering, with a d₁₀ value of ≥2.0 nm and d₉₀ value of ≤7.0 nm.

8. The catalyst composition of claim 7, wherein the volume weighted particle size distribution of the platinum particles has a median value d₅₀, which lies in the range of 3.0-5.0 nm.

9. The catalyst composition of claim 7, wherein d₁₀≥2.0 nm and d₉₀≤6.5 nm.

10. The catalyst composition of claim 7, wherein the d₁₀, d₉₀ and d₅₀ values of the particle size distribution of the platinum particles meet the following condition:
(d₉₀−d₁₀)/d₅₀≤1.0.

11. The catalyst composition of claim 7, wherein the metallic platinum particles are present in the catalyst composition in a quantity of 5-60% by weight.

12. An electrochemical cell comprising a catalyst composition according to claim 7.

13. A method for catalyzing an electrochemical reaction comprising performing an electrochemical reaction in the presence of a catalyst composition according to claim 7.

14. The method of claim 13, wherein the electrochemical reaction is any one of the electrochemical reduction of oxygen, the electrochemical oxidation of hydrogen, the electrochemical formation of oxygen from water or the electrochemical formation of hydrogen from water.

15. The method of claim 5, wherein the Reynolds number of the stirrer in step (ii) lies in the range of 90,000-150,000 and/or the pH of the aqueous medium in step (ii) lies in the range of 4.9-5.3.

16. The catalyst composition of claim 11, wherein the metallic platinum particles are present in the catalyst composition in a quantity of 15-50% by weight.

17. The catalyst composition of claim 8, wherein the volume weighted particle size distribution of the platinum particles has a median value d₅₀, which lies in the range of 3.5-4.5 nm.

18. The catalyst composition of claim 9, wherein d₁₀≥2.3 nm and d₉₀≤6.0 nm.

19. The electrochemical cell of claim 12, wherein the electrochemical cell is a fuel cell or an electrolysis cell.
